(19) United States
(12) Patent Application Publication
(10) Pub. No.: US 2014/0097603 A1
(43) Pub. Date: Apr. 10, 2014

(54) Exterior Airbag Cushion for Vehicle

(71) Applicant: HYUNDAI MOTOR COMPANY, Seoul (KR)

(72) Inventors: Tae Wook Chung, Seoul (KR); Yong Sun Kim, Namyangju-si (KR); Seoung Hoon Lee, Suwon-si (KR); Jin Ho Bae, Suwon-si (KR)

(73) Assignee: Hyundai Motor Company, Seoul (KR)

(21) Appl. No.: 13/713,809

(22) Filed: Dec. 13, 2012

(30) Foreign Application Priority Data
Oct. 10, 2012 (KR) 10-2012-0112350

(51) Int. Cl. B60R 19/20

(52) U.S. Cl. CPC B60R 19/205
USPC 280/770

(57) ABSTRACT

An exterior airbag cushion for a vehicle includes a cushion body which is deployed forward from a front end of the vehicle, a vent hole which is formed in the cushion body, and a variable guide which has a cover shape and covers the vent hole in such a way that a first end and opposing side edges of the variable guide are fastened to the cushion body, and a second end thereof is open to form an opening. The variable guide is folded and is brought into close contact with the cushion body and temporarily fastened to the cushion body so that the variable guide guides a direction of gas discharged from the vent hole and the opening when a temporary fastening structure is loosened by internal pressure of the cushion body.

### CROSS-REFERENCE TO RELATED APPLICATION

The present application claims priority of Korean Patent Application Number 10-2012-0112350 filed Oct. 10, 2012, the entire contents of which application is incorporated herein for all purposes by this reference.

### BACKGROUND OF INVENTION

1. Field of Invention

The present invention relates to an exterior airbag cushion for a vehicle which is deployed forward from a front bumper of the vehicle to absorb shock on impact.

2. Description of Related Art

Exterior airbags are provided in front bumpers of vehicles. Such an exterior airbag is deployed forward when detecting danger of collision, thus protecting the vehicle on impact.

FIG. 1 is an exploded perspective view showing an exterior airbag. The exterior airbag is installed in a bumper 10. In detail, when an airbag module 30 is deployed from a bumper back beam 40, it protrudes and expands outward from the bumper 10 under the guidance of a deployment guide 20.

FIG. 2 is a view showing an exterior airbag cushion which was proposed by the applicant of the present invention but is not yet published. The exterior airbag cushion C has a box shape and is deployed in a lateral direction along a front end of a bumper of a vehicle in a shape in which the cushion C covers the bumper. A vent hole 54 is formed in one end of the cushion C, and a vent cover 52 which covers the vent hole 54 is provided on the cushion C by sewing 56.

If high-temperature and high-pressure gas is used, the vent cover 52 is made of material which is melted at a predetermined temperature or more. In this case, when gas is charged into the cushion C, the vent cover 52 melts at the predetermined temperature or more and opens the vent hole 54.

However, in such a vent structure, the timing at which the vent cover 52 melts is not constant. In other words, it is very difficult to secure accurate timing for venting.

Furthermore, a portion of the vent cover 52 that melts is irregular so that gas may be undesirably discharged outwards, thus causing a problem of a safety risk

Therefore, a vent structure which can secure the constant timing for venting and reliably guide gas sideways is required.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the prior art. Various aspects of the present invention provide for an exterior airbag cushion for a vehicle which can secure constant timing for venting and reliably guide gas sideways.

Various aspects of the present invention provide for an exterior airbag cushion for a vehicle, including a cushion body to be deployed forward from a front end of the vehicle; a vent hole formed in the cushion body; and a variable guide having a cover shape and covering the vent hole in such a way that a first end and opposite side edges of the variable guide are fastened to the cushion body, and a second end thereof is open to form an opening, the variable guide being folded and being brought into close contact with the cushion body and temporarily fastened to the cushion body so that the variable guide guides a direction of gas discharged from the vent hole and the opening when a temporary fastening structure is loosened by internal pressure of the cushion body.

The variable guide may include an upper surface and opposite side surfaces, wherein a first end of the upper surface and lower edges of the opposite side surfaces may be fastened to the cushion body such that the opening is formed by a second end of the upper surface.

The temporary fastening structure of the variable guide may comprise a sewn line.

Furthermore, after the variable guide has been folded and been brought into close contact with the cushion body, the second end of the variable guide may be temporarily fastened to the cushion body.

The second end of the variable guide may be configured such that only a portion thereof is temporarily fastened to the cushion body as long as the variable guide is brought into close contact with the cushion body, whereby initial gas is discharged through a remaining portion of the second end that is not fastened to the cushion body, and when the internal pressure of the cushion body increases to a predetermined level, the temporary fastening structure is loosened and entirety of the second end of the variable guide opens.

In addition, after the variable guide has been folded and been brought into close contact with the cushion body, the opposite side edges of the variable guide may be temporarily fastened to the cushion body.

The variable guide may have an upper surface and opposite triangular side surfaces, wherein a first end of the upper surface and lower edges of the opposite triangular side surfaces may be fastened to the cushion body such that the opening is formed by a second end of the upper surface.

The variable guide may be brought into close contact with the cushion body and be fastened thereto in such a way that the opposite triangular side surfaces of the variable guide are folded.

The opposite triangular side surfaces of the variable guide may be folded inward or outward so that the variable guide is brought into close contact with the cushion body and is fastened thereto.

Various aspects of the present invention provide for an exterior airbag cushion for a vehicle, including: a cushion body to be deployed forward from a front end of the vehicle; a vent hole formed in the cushion body; and a variable guide having a cover shape and coupled to the cushion body to cover the vent hole, with an opening formed in one end of the variable guide, the variable guide being folded and being brought into close contact with the cushion body and temporarily fastened to the cushion body so that the variable guide guides a direction of gas discharged from the vent hole and the opening when a temporary fastening structure is loosened by internal pressure of the cushion body.

In an exterior airbag cushion for a vehicle according to the present invention, the timing for venting is constant, and gas can be reliably guided sideways.

Furthermore, the diameter of a vent hole and the size of an opening can be adjusted to control a discharge rate of gas. Thus, the degree of freedom of design can be enhanced. In addition, the orientation of the opening can be easily modified, so that the position from which gas is discharged and the direction in which gas is discharged can be easily adjusted.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the installation of an exterior airbag;

FIG. 2 is a view showing a vent of a conventional exterior airbag cushion;

FIG. 3 is a partial view showing an exemplary exterior airbag cushion of a vehicle, according to the present invention;

FIGS. 4A through 4C are views showing a venting process of the exterior airbag cushion of FIG. 1; and

FIGS. 5 through 8 are views of different exemplary exterior airbag cushions for a vehicle according to the present invention.

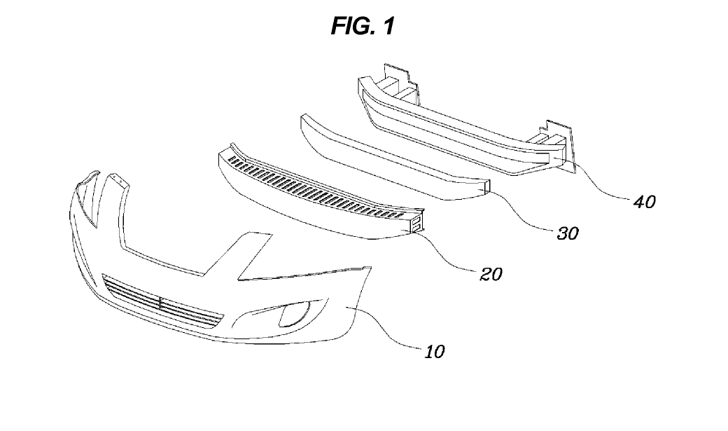

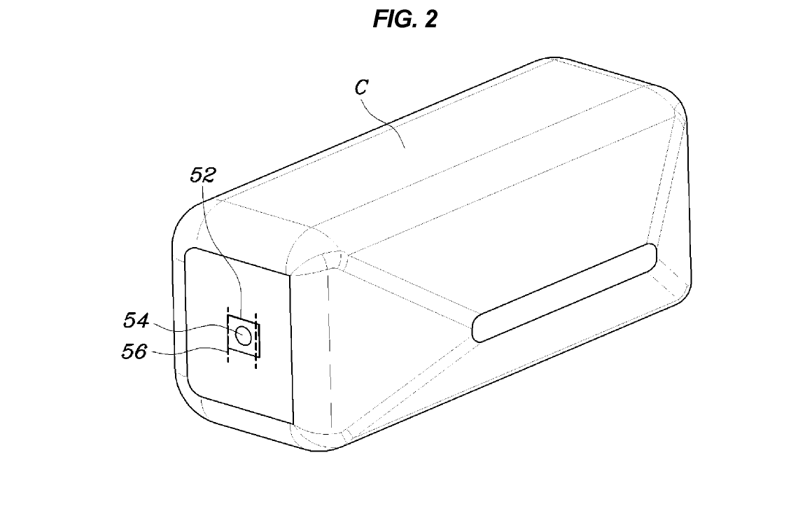

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

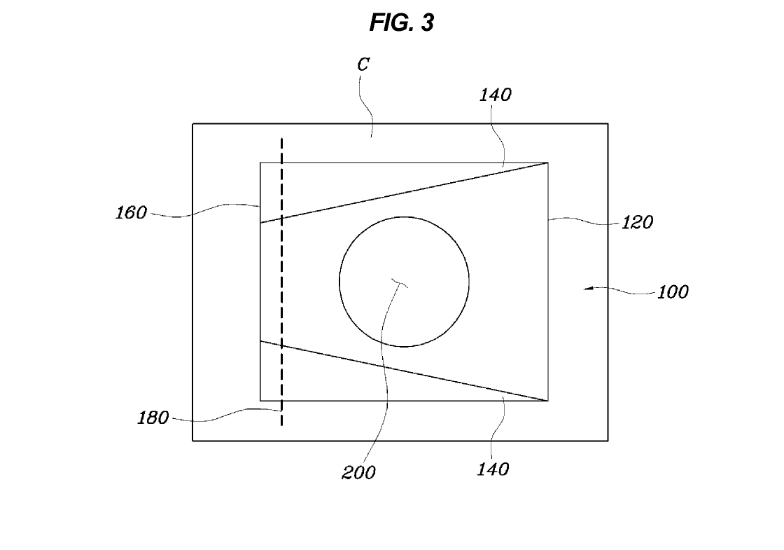

FIG. 3 is a partial view showing an exterior airbag cushion of a vehicle, according to various embodiments of the present invention. The exterior airbag cushion includes: a cushion body C which is deployed forward from a front end of the vehicle; a vent hole 200 which is formed in the cushion body C; and a variable guide 100 which has a cover shape and is coupled to the cushion body C to cover the vent hole 200. An opening 162 is formed in one end of the variable guide 100. The variable guide 100 is folded, is brought into close contact with the cushion body C, and is temporarily fastened to the cushion body C. The variable guide 100 guides direction of gas discharged from the vent hole 200 and the opening 162 when a temporary fastening structure 180 is loosened by internal pressure of the cushion body C.

In detail, the shape of the variable guide 100 is that of a cover which covers the vent hole 200. A first end 120 and opposite side edges 140 of the variable guide 100 are fastened to the cushion body C, and a second end 160 thereof is open so that the opening 162 is formed. The opening 162 functions as a discharge hole through which gas is discharged. Gas that has been discharged from the vent hole 200 is blocked by the variable guide 100 and is discharged to the outside through the opening 162. As a result, the direction in which gas is discharged can be controlled by the variable guide 100. Therefore, if the opening 162 is oriented in the lateral direction of the vehicle, secondary damage can be prevented.

Further, the variable guide that has been brought into close contact with the cushion body C and been temporarily fastened to the cushion body C guides the direction of gas discharged from the vent hole 200 and the opening 162 when the temporary fastening structure 180 is loosened by the internal pressure of the cushion body C. Hence, the variable guide 100 functions not only as an active vent which conducts venting after the internal pressure of the airbag cushion C has been increased to a predetermined level, but also as a guide which controls the direction in which gas is discharged.

The variable guide 100 includes an upper surface 122 and opposite side surfaces 142. The first end of the upper surface 122 and the lower edges of the opposite side surfaces 142 are fastened to the cushion body C such that the opening 162 is formed by the second end of the upper surface 122. The variable guide 100 is configured such that the cross-sectional area of space defined by the variable guide 100 is increased from the first end 120 to the opening 162 so that gas can be smoothly discharged to the outside.

The temporary fastening structure 180 of the variable guide 100 comprises a sewn line. When the internal pressure of the airbag cushion C reaches a predetermined level, the sewn line is ripped so that gas can be discharged through the opening 162. The strength of the active venting can be controlled by adjusting the thickness of the sewn line or the number of sewn lines.

Furthermore, the variable guide 100 is folded and is brought into close contact with the cushion body C, and then the second end 160 thereof is temporarily fastened to the cushion body C.

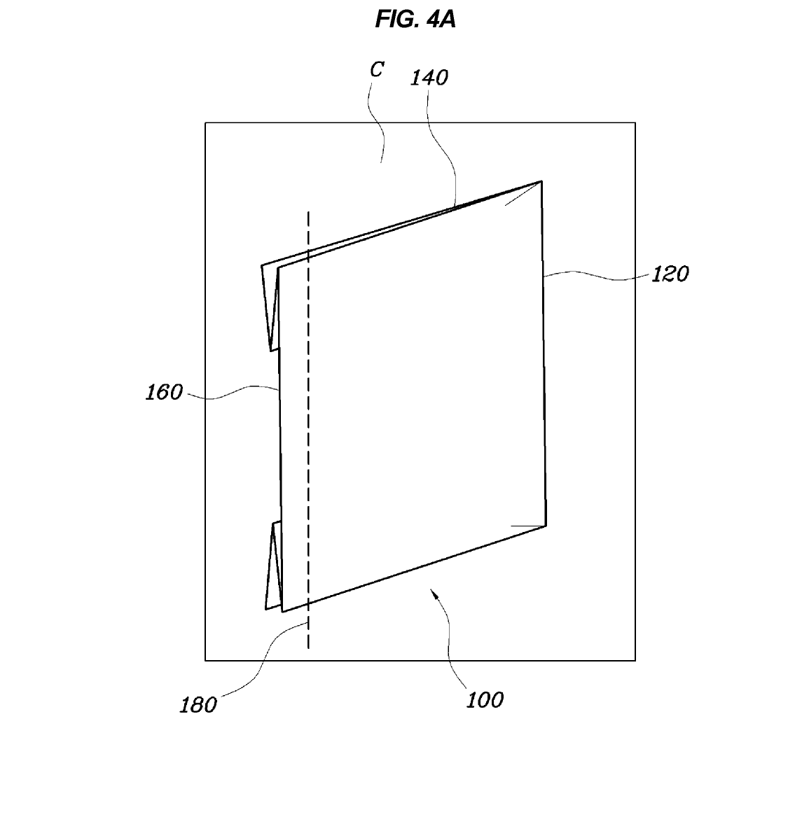

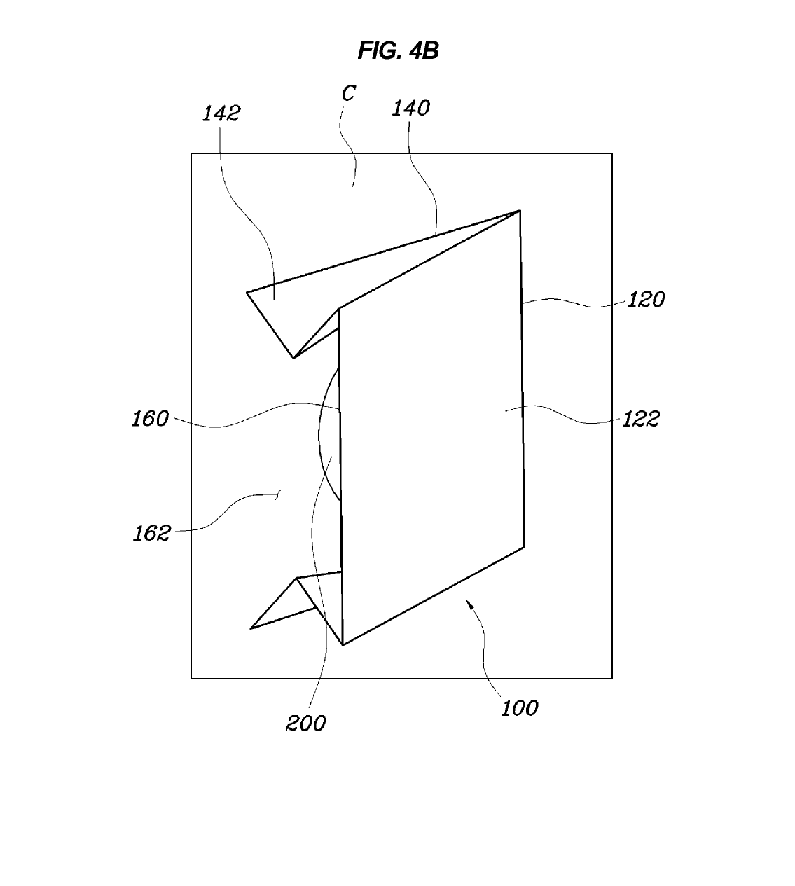

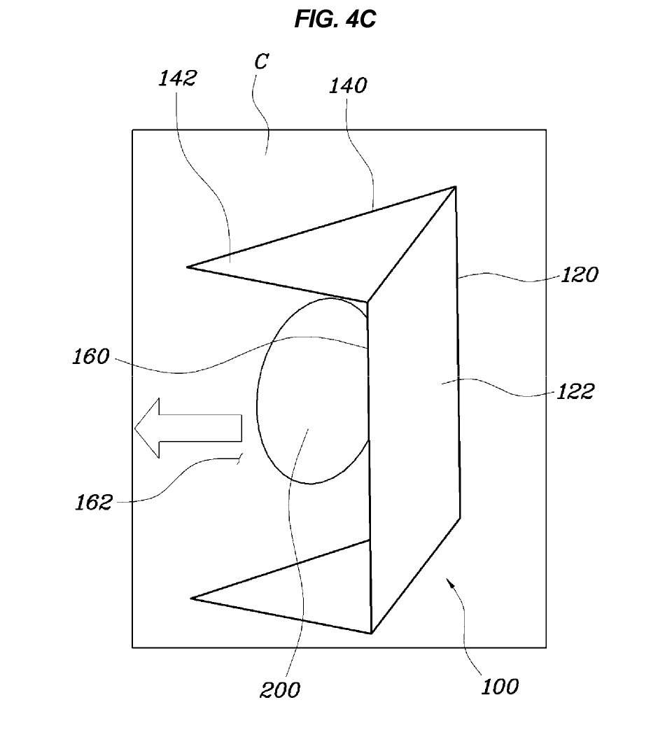

FIGS. 4A through 4C are views showing a venting process of the exterior airbag cushion C. FIG. 4A illustrates a state in which no internal pressure is applied to the airbag cushion C. In this case, the sewn line is not yet ripped. The variable guide 100 that has been folded on the airbag cushion C and temporarily fastened thereto is maintained intact

FIG. 4B shows a moment at which the sewn line is broken. FIG. 4C shows a state in which the variable guide 100 that has been folded is completely unfolded and the venting operation is being conducted. Here, because the variable guide 100 is configured such that the cross-sectional area of the space defined by the variable guide 100 is gradually increased, gas can be smoothly discharged. In addition, the variable guide 100 can reliably guide gas toward the opening 162 through which gas is discharged to the outside.

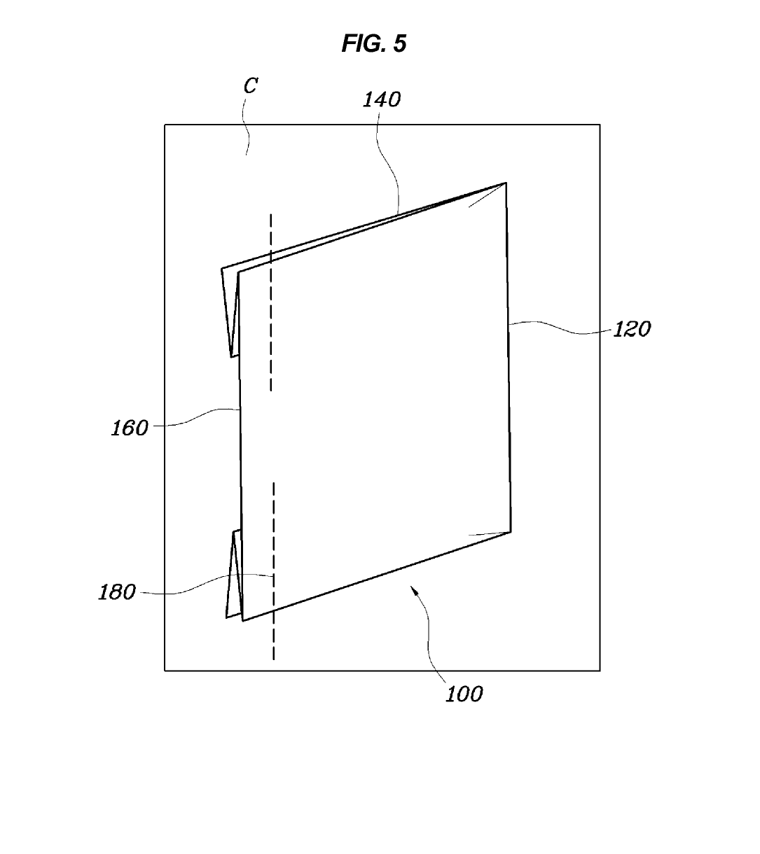

The second end 160 of the variable guide 100 may be configured such that only a portion thereof is temporarily fastened to the cushion body C as long as the variable guide 100 can come into close contact with the cushion body C. In this case, initial gas is discharged through the other portion of the second end 160 that is not fastened to the cushion body C, and when the internal pressure of the cushion body C increases to a predetermined level, the temporary fastening structure 180 is loosened and the entirety of the second end 160 of the variable guide 100 opens. This case is illustrated in FIG. 5. In detail, when an inflator explodes, initial gas is discharged through the unfastened portion, and then the sewn line of the variable guide 100 is broken and the temporary fastening structure 180 is loosened so that the entirety of the second end 160 of the variable guide 100 opens. As such, the strength of the active venting and the discharge rate of gas can be controlled in stages.

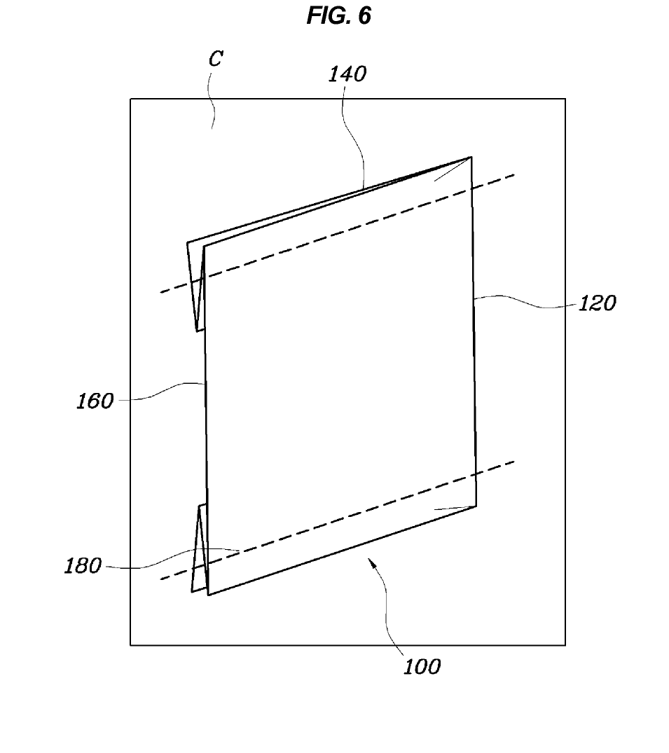

Alternatively, the variable guide 100 may be configured such that, as shown in FIG. 6, the opposite side edges 140 are temporarily fastened to the cushion body C after the variable guide 100 has been folded and been brought into close contact with the cushion body C. In this case, at an initial stage, some gas is discharged to the outside through gap defined in the second end of the variable guide 100. After the temporary fastening structure 180 is ripped, gas is completely discharged to the outside through the second end 160.

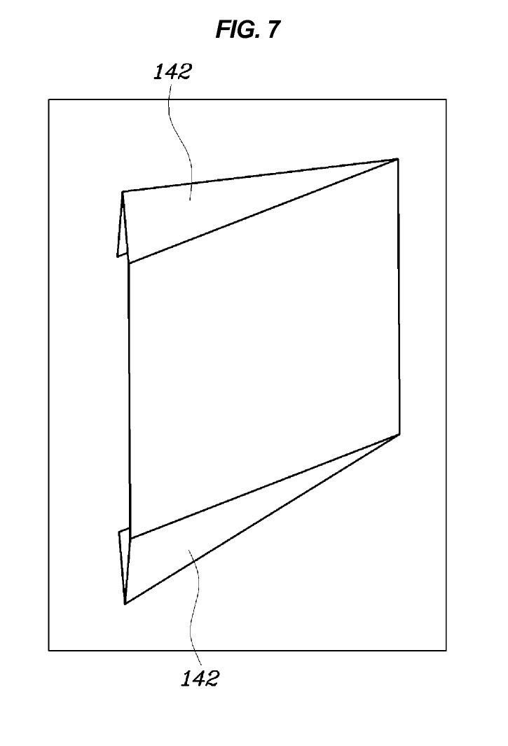

As a further alternative, the variable guide 100 may include an upper surface 122 and opposite triangular side surfaces 142. A first end of the upper surface 122 and lower edges of the opposite triangular side surfaces 142 are fastened to the cushion body C such that an opening 162 is formed by a second end of the upper surface 122. The variable guide 100 guides gas in a direction in which the cross-sectional area of space defined by the variable guide 100 gradually increases. As shown in FIG. 7, the variable guide 100 is brought into close contact with the cushion body C in such a way that the opposite side surfaces 142 are folded. The opposite side surfaces 142 may be folded in a variety of manners, for example, inward or outward, so that the variable guide 100 can be brought into close contact with the cushion body C and be fastened to the cushion body C.

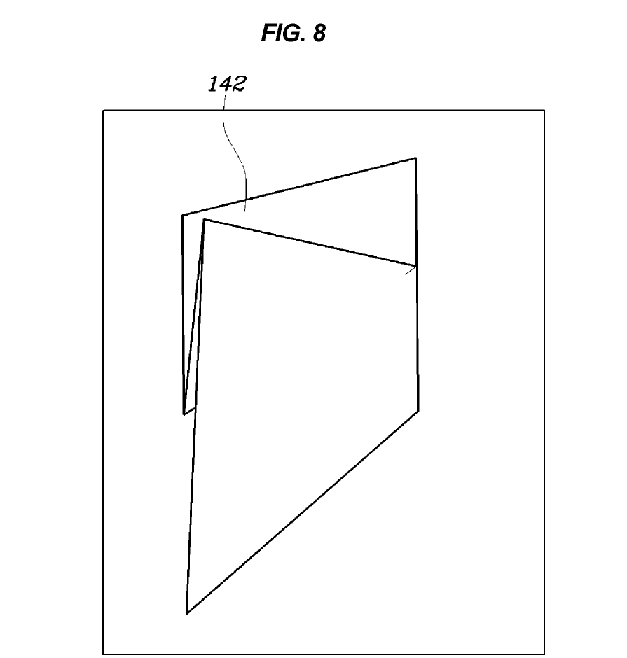

FIG. 8 illustrates an example in which the variable guide 100 is folded only in one direction. As necessary, the method of fastening the variable guide 100 to the airbag cushion can be variously modified.

As described above, in an exterior airbag cushion for a vehicle according to the present invention, the timing for venting is constant. The direction in which gas is discharged out of the airbag cushion can be guided such that it is oriented in the lateral direction of the vehicle.

Furthermore, the diameter of the vent hole and the size of the opening can be adjusted to control a discharge rate of gas. Thus, the degree of freedom of design can be enhanced. Furthermore, the orientation of the opening can be easily modified, so that the position from which gas is discharged and the direction in which gas is discharged can be easily adjusted.

For convenience in explanation and accurate definition in the appended claims, the terms upper or lower, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An exterior airbag cushion for a vehicle, comprising:
a cushion body to be deployed forward from a front end of the vehicle;
a vent hole formed in the cushion body; and
a variable guide having a cover shape and covering the vent hole in such a way that a first end and opposing side edges of the variable guide are fastened to the cushion body, and a second end thereof is open to form an opening, the variable guide being folded and being brought into close contact with the cushion body and temporarily fastened to the cushion body so that the variable guide guides a direction of gas discharged from the vent hole and the opening when a temporary fastening structure is loosened by internal pressure of the cushion body.

2. The exterior airbag cushion as set forth in claim 1, wherein the variable guide comprises an upper surface and opposing side surfaces, wherein a first end of the upper surface and lower edges of the opposing side surfaces are fastened to the cushion body such that the opening is formed by a second end of the upper surface.

3. The exterior airbag cushion as set forth in claim 1, wherein the temporary fastening structure of the variable guide comprises a sewn line.

4. The exterior airbag cushion as set forth in claim 1, wherein after the variable guide has been folded and been brought into close contact with the cushion body, the second end of the variable guide is temporarily fastened to the cushion body.

5. The exterior airbag cushion as set forth in claim 4, wherein the second end of the variable guide is configured such that only a portion thereof is temporarily fastened to the cushion body as long as the variable guide is brought into close contact with the cushion body, whereby initial gas is discharged through a remaining portion of the second end that is not fastened to the cushion body, and when the internal pressure of the cushion body increases to a predetermined level, the temporary fastening structure is loosened and entirety of the second end of the variable guide opens.

6. The exterior airbag cushion as set forth in claim 1, wherein after the variable guide has been folded and been brought into close contact with the cushion body, the opposing side edges of the variable guide are temporarily fastened to the cushion body.

7. The exterior airbag cushion as set forth in claim 1, wherein the variable guide comprises an upper surface and opposing triangular side surfaces, wherein a first end of the upper surface and lower edges of the opposing triangular side surfaces are fastened to the cushion body such that the opening is formed by a second end of the upper surface.

8. The exterior airbag cushion as set forth in claim 7, wherein the variable guide is brought into close contact with the cushion body and is fastened thereto in such a way that the opposing triangular side surfaces of the variable guide are folded.

9. The exterior airbag cushion as set forth in claim 7, wherein the opposing triangular side surfaces of the variable guide are folded inward or outward so that the variable guide is brought into close contact with the cushion body and is fastened thereto.

10. An exterior airbag cushion for a vehicle, comprising:
a cushion body to be deployed forward from a front end of the vehicle;
a vent hole formed in the cushion body; and
a variable guide having a cover shape and coupled to the cushion body to cover the vent hole, with an opening formed in one end of the variable guide, the variable guide being folded and being brought into close contact with the cushion body and temporarily fastened to the cushion body so that the variable guide guides a direction of gas discharged from the vent hole and the opening when a temporary fastening structure is loosened by internal pressure of the cushion body.
